(19) United States
(12) Patent Application Publication
(10) Pub. No.: US 2011/0017854 A1
(43) Pub. Date: Jan. 27, 2011

(54) GRINDER WITH DOUBLE FORCED MOVEMENT OF THE GRINDING MEDIUM

(75) Inventors: Tadeusz Kapcia, Lubaczow (PL); Alicja Czernicka, Koszalin (PL)

Correspondence Address: ZIEGLER IP LAW GROUP, LLC., 518 RIVERSIDE AVENUE, BUILDING B (Synergy), WESTPORT, CT, 06880, US

(73) Assignee: PRZEDSIEBIORSTWO INNOWACYJNO-WDROZENIOWE, Lubaczow (PL)

(21) Appl. No.: 12/674,668

(22) PCT Filed: Sep. 3, 2008
(86) PCT No.: PCT/PL2008/000063

§ 371 Date: Oct. 13, 2010

(30) Foreign Application Priority Data
Sep. 10, 2007 (PL) P.383313

(51) Int. Cl. B02C 17/04

(52) U.S. Cl. 241/175

(57) ABSTRACT

A grinder includes a double forced movement in which the movement of the grinding medium in the chambers of the grinder drum is forced by a vibrator device as well as by the drum itself. The combination of the vibrating movement of the rotating grinding medium, which is caused by the vibrator with the rotary movement of the grinding medium, in turn resulting from the rotation of the drum around an eccentrically shifted axis, significantly increases the centrifugal forces of the grinding medium and causes the creation of a layer of rotating grinding medium together with the grinded material inside the drum chamber, while the thickness of the layer is thereby differentiated.

### CROSS-REFERENCE TO RELATED APPLICATIONS

This application is the US National Stage of International Application No. PCT/PL2008/000063, International Filing Date 3 Sep. 2008, which designated the United States of America and which was published under PCT Article 21 (2) as WO Publication No. 2009/035353 on 19 Mar. 2009, and which claims priority to Polish Application No. P.383313, filed on 10 Sep. 2007, the disclosures of which are incorporated herein by reference in their entireties.

### BACKGROUND

1. Field

The aspects of the disclosed embodiments relate to a grinder with double forced movement of the grinding medium, in which the movement of the grinding medium inside the drum chambers of the grinder is forced by a vibrator device as well as by the rotation of the drum itself.

2. Brief Description of Related Developments

The vibrating grinder, described in the Polish patent application No. P.320538, contains one or more chambers mounted on brackets, in which the mountings of the bracket bearings are thereby situated. The aforementioned mountings together with the chambers constitute a vibrating assembly, which is driven by a mechanical, kinematic vibrator that comprises two shafts that are situated in bearings and are equipped with eccentrics that have bearings. This vibrating assembly is also equipped with concentrated mass weights, while the center of gravity of these weights is shifted by 180° with respect to the center of gravity of the vibrating assembly. At least one pair of bearings for one and/or two shafts is situated in elastic elements that are mounted in holders. On both shafts of the vibrator there is at least one container that contains additional weights in the form of a free mass in turn constituting small elements of the loading.

The rotary-vibrating grinder with serial chambers, described in the Polish invention application No. P.359118, comprises a drum, which is supported on bearings at the input pivot on one side and at the outlet element on the other side. The supporting structure of the grinder is placed on six vibrators that are mounted on a combined footing. The grinder drum comprises three circular chambers, which are shifted alternately and eccentrically to each other in relation to the axis of the drum rotation. The circular cross-sections of the chambers as well as their eccentricity are chosen in such a way that the centrifugal forces occurring in these three chambers during the drum rotation shall be mutually equilibrated. This eccentric shift of the internal cross-sections of the drum chambers in relation to their rotation axis causes the vibration of the grinding medium as well as the grinded material. The rotation of the grinder drum is chosen in such a way that the centrifugal forces that affect the grinding medium and grinded material are several times stronger than the gravitation force.

The disadvantage of the known constructions of rotary-vibrating grinders is their low grinding efficiency, which is caused by the fact that only the vertical forces of the vibration motion affect the grinding medium and grinded material.

### SUMMARY

The essence of the construction of a grinder with the double forced movement of the grinding medium of the disclosed embodiments, is to generate significant centrifugal forces to affect the charge, i.e. the grinding medium and the grinded material, inside the grinder drum. The aforementioned forces are generated by a mechanical, kinematic vibrator that comprises two eccentric shafts that are situated in the bearings as well as in the supporting structure of the drum and by the rotation of the drum with eccentrically situated chambers. The mechanical, kinematic vibrator performs the movement along the circular trajectory. The mechanical, kinematic vibrator comprises a supporting structure for the drum, which is mounted on two eccentric shafts. The vibrator forces the movement of the grinding medium, which vibrates along the circular trajectory and in this way both the grinding medium and grinded material move inside the drum chamber in the direction opposite to the direction of the vibrator movement. An additionall rotational movement of the drum around its own, eccentrically shifted, axis, which is forced by the appropriately chosen rotation speed of the drum with eccentrically situated chambers, causes an additional increase of the forces that affect the grinding medium and grinded material. The combination of the vibrating movement of the rotating grinding medium, which is caused by the vibrator with the rotary movement of the grinding medium, in turn resulting from the rotation of the drum around an eccentrically shifted axis, significantly increases the centrifugal forces of the grinding medium and causes the creation of a layer of rotating grinding medium together with the grinded material inside the drum chamber, while the thickness of the said layer is thereby differentiated. This differentiated thickness of the rotating grinding medium and grinded material causes, in addition to centrifugal forces, forces that are tangential to the drum cross-section, which affect both the grinding medium and grinded material.

The increased centrifugal forces present in this grinder, in turn cause the disintegration of the grinded material by stroke, while the additional tangential forces cause the abrasion of the material that is located inside the grinder.

The grinder with the double forced movement of the grinding medium comprises of a mechanical kinematic vibrator, a drum or drums, and one gear. Each drum or drums may comprise one or more chambers, which are filled with the charge. The mechanical, kinematic vibrator, which produces movement along a circular trajectory, is made of a supporting structure for the drum, which is mounted on two eccentric shafts by means of bearings. In the case of a grinder that comprises a single drum, the centrifugal forces that affect the supporting structure of the drum, which are caused by the rotation of the vibrator, are equilibrated by the additionally installed counterweight mass. In the case of a grinder that comprises a higher amount of drums, each individual drum along with its supporting structure constitutes its own counterweight for the inertial forces that affect the crankshaft, which is an element of the vibrator. In the case of a grinder that comprises two or more drums, each of which that have two or more chambers, two two-part, double-eccentric shafts are mounted in the bearings. The two-part structure of the double-eccentric shafts makes it possible to mount the bearings and supporting structures of the drum. Each drum is mounted rotationally in bearings. In the case of a single-chamber drum, the chamber axis is shifted by the eccentricity dimension with regard to the rotation axis of the drum, which is defined by two pivots. In the case of a drum with more than one chamber, these chambers are located parallel to each other and are shifted alternately to each other by the eccentricity dimension with respect to the axis of the drum rotation. As the counterweight for the inertial forces of one drum and its supporting structure, there are two or more drums together with their supporting structures, while the sum of their inertial forces is equal to the inertial force of the first drum. The size of the grinder drums in one single grinder of the present invention is optional, however, it must be selected in such a way that the occurring inertial forces that result from the vibrator movement and affect the drums must be mutually equilibrated. The rotation around the eccentric axis of the individual drums of the grinder can be chosen freely according to any required grinding parameters. It is in this way that the required grain-size distribution of the grained material can be reached. The rotation of the vibrator shafts, which are driven by an engine via its supporting structure, force the movement of the drums along a circular trajectory and causes, thereby, the flat, circular movement of the grinding medium and grinded material. The individual pivots of the grinder drums are connected to the vibrator shaft by means of any belt, chain, gear, or another transmission, depending on the required direction of the rotation, and can, thereby, force the eccentric rotary movement of the drum or drums of the grinder. The individual chambers of each drum can be separated with screen membranes and are shifted alternately by the eccentricity dimension in relation to the drum rotation axis.

The advantage of the grinder with the double forced movement of the grinding medium, as disclosed herein, are the obtained, significantly stronger, centrifugal forces, which affect the grinding medium and grinded material compared to the hitherto known grinders. The vibrating movement of the vibrator along a circular trajectory, combined with the drum rotation around its own axis, results in the most effective grinding compared to the hitherto known rotary-vibrating grinders, in which only vertical vibration is used.

### BRIEF DESCRIPTION OF THE DRAWINGS

An example of the execution of the grinder with the double forced movement of the grinding medium is shown in the drawings, wherein:

FIG. 1 shows a kinematic scheme of a grinder with two drums;

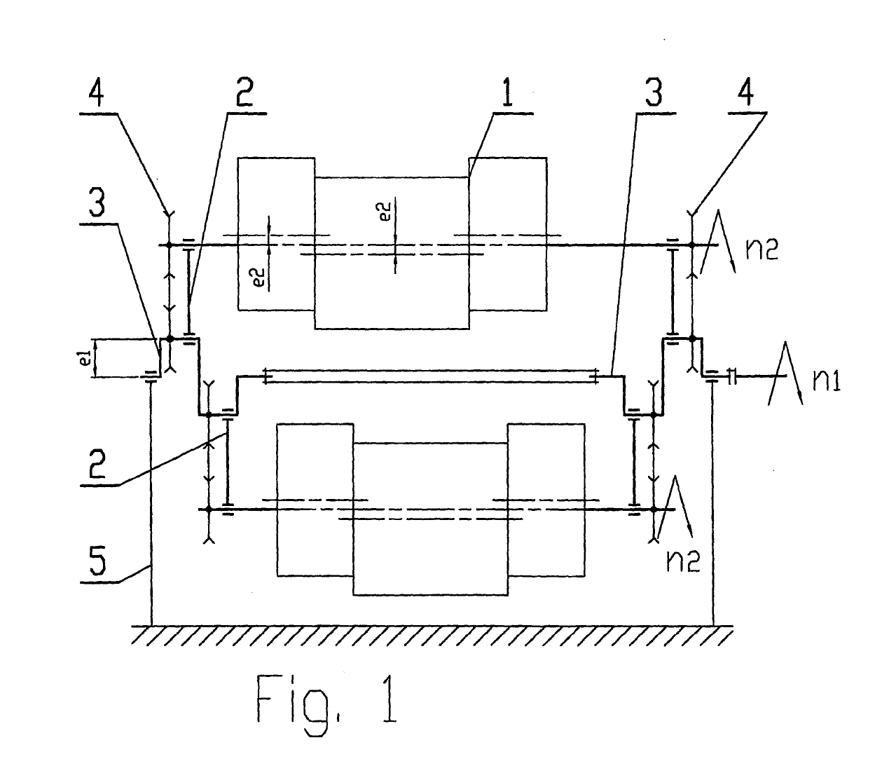

FIG. 2 shows a kinematic scheme in a lateral projection of the grinder with two drums;

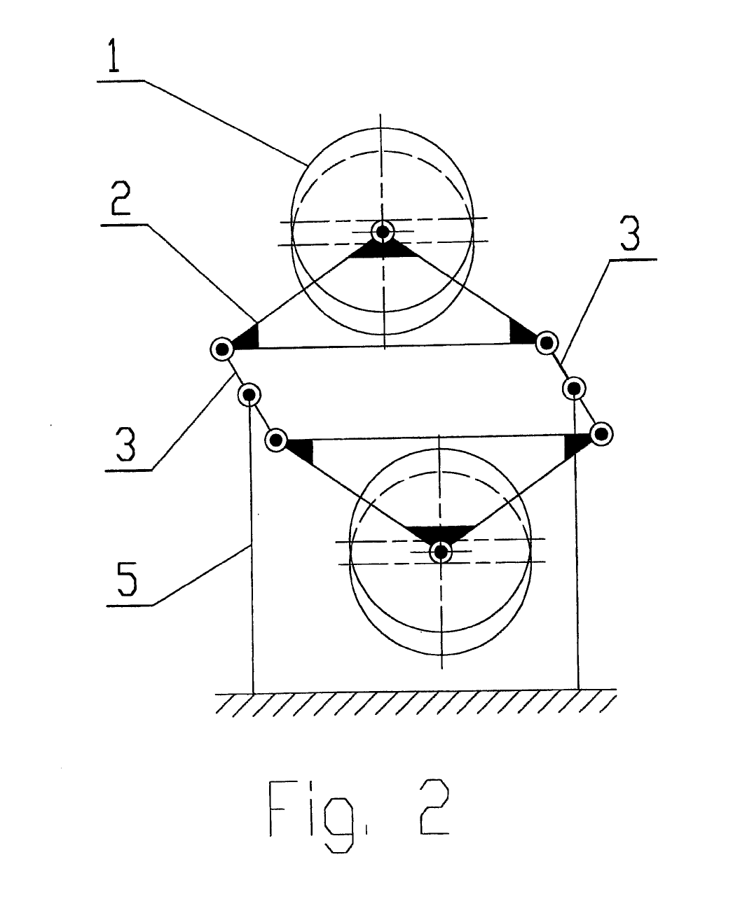

FIG. 3 shows a kinematic scheme of a grinder with three drums;

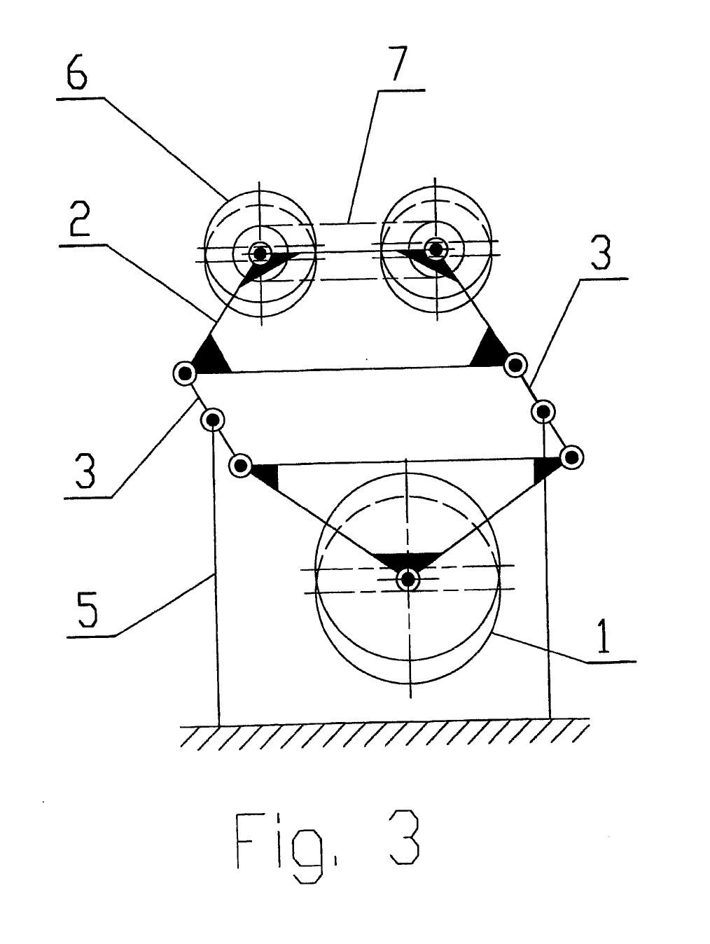

FIG. 4 shows a kinematic scheme of a grinder with one drum; and

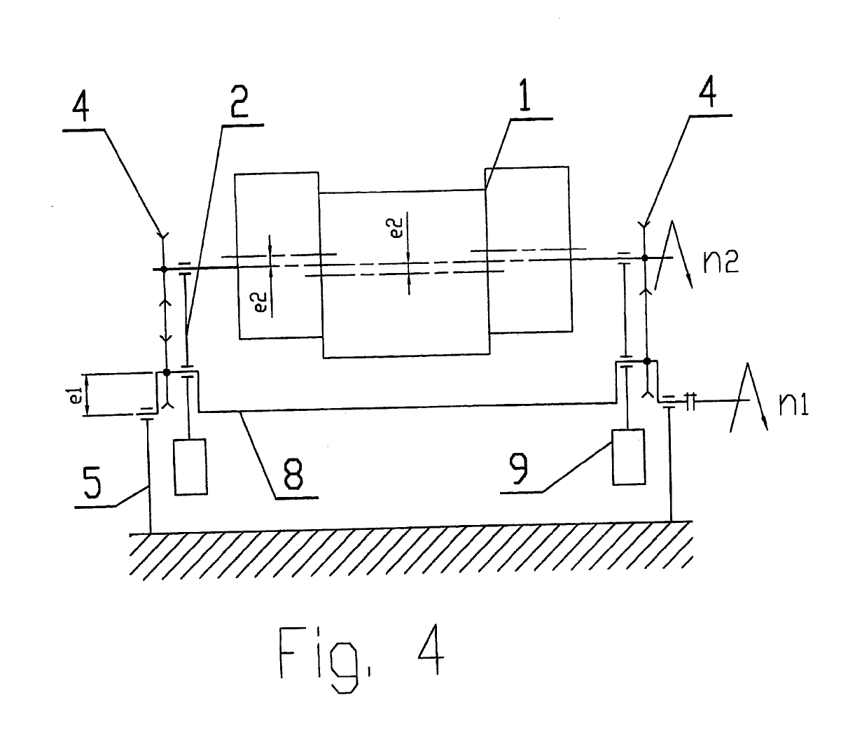

FIG. 5 shows a chamber cross-section, which is the location of the grinding medium and grinded material in a grinder chamber during its operation.

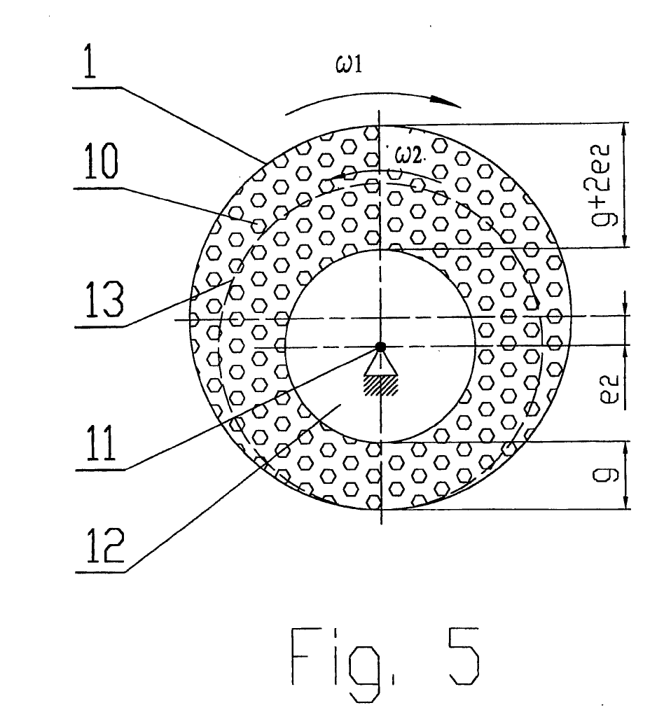

### DETAILED DESCRIPTION OF THE DISCLOSED EMBODIMENTS

The grinder with the double forced movement of the grinding medium according to the disclosed embodiments comprises a frame 5, a drum 1 or drums 1, a vibrator with eccentric shafts 3, a supporting structure 2 for the drum 1, and a gear 4. In the case of a grinder of the present invention, that comprises a single drum 1, the vibrator is equipped with an eccentric shaft 8 and with additional masses 9 situated on the supporting structure 2, that constitute a drum counterweight 1 during grinder operation. The drum 1 has three parallel chambers 13, which are shifted alternately by the eccentricity dimension e2 in relation to the rotation axis of the drum 1. The shaft 3 or the vibrator shaft 8, which are driven by an engine, are mounted in the frame 5 bearings. There is a supporting structure 2 of the drum 1 that is mounted in the bearings on the eccentric shafts 3 with an eccentricity dimension “e1”, in which drum 1 is mounted rotationally in the bearings on that supporting structure. The rotation is transmitted from the engine to the eccentric shafts 3 and further on from these shafts via a gear 4 to the shafts 3 of the second and next drums 1. In the case of a grinder with three drums, the two drums 6 of a smaller diameter are mounted on common supporting structures, which can be additionally coupled by means of an additional gear 7. In the case of a grinder that consists of two or more drums 1, the supporting structures 2 for the drums 1 are mounted on the eccentric shafts 3.

During the grinder's operation, the rotation “ω2” of the charge 10, i.e. the grinding medium and the grinded material, in the chamber 13 is opposite to the rotation “ω1” of the chamber 13 of the drum 1. During the rotation of the chamber 13 around the axis leading through the point 11 and shifted from the centre of the chamber 13 by the eccentricity dimension “e2”—the thickness of the charge 10 layer varies within the range of g to g+2e.

What is claimed is:

1. A grinder with a double forced movement of a grinding medium, comprising:
a drum comprising one or more circular chambers,
a mechanical kinematic vibrator, which is created by two shafts that are mounted in bearings and equipped with eccentrics that have bearings, in which this vibrator is also equipped with weights, wherein the circular chambers of the drum are alternately shifted eccentrically with respect to a rotational axis, wherein said grinder comprises a drum or drums that are mounted rotationally with bearings, while the drum or drums rotate around its own eccentrically shifted axis simultaneously with the vibration of the drum or drums along a circular trajectory where, furthermore, this grinder comprises a mechanical kinematic vibrator and a gear, while the mechanical kinematic vibrator with vibration movement along the circular trajectory comprises a supporting structure of the drum or drums, which is mounted in bearings on two eccentric shafts that are driven by an engine, while the vibrator, via eccentric shafts is mounted in bearings on a grinder frame, while the gear couples the eccentric shaft with a drum pivot.

2. A grinder, as defined in claim 1, wherein each drum comprises one or more eccentrically situated chambers, shifted alternately with respect to the rotation axis of the drum by an eccentricity dimension, while the chambers are filled with a charge.

3. A grinder, as defined in claim 1, wherein inertial forces occurring in the grinder and that affect the drum through the supporting structure of the drum are equilibrated by the remaining drums of the grinder.

4. A grinder, as defined in claim 1, wherein, in the case of a grinder containing more than one drum, each remaining drum of the grinder has any diameter, length, and number of chambers.

5. A grinder, as defined in claim 1, wherein in the bearings that are situated in the grinder frame there are two mounted two-part, double-eccentric shafts.

6. A grinder, as defined in claim 1, wherein the rotational speed of each drum of the grinder can be different.

7. A grinder, as defined in claim 1, wherein the gear transmits the rotation of the eccentric shaft on the drum pivot of the drum or drums.
